(19) United States
(12) Patent Application Publication
(10) Pub. No.: US 2022/0390257 A1
(43) Pub. Date: Dec. 8, 2022

(54) AUTO-CALIBRATION FOR MULTI-POLE ANGLE SENSORS WITH MECHANICAL MODULATION

(71) Applicant: Allegro MicroSystems, LLC, Manchester, NH (US)

(72) Inventors: Sergio Nicolás Deligiannis, Buenos Aires (AR); Nicolás Rigoni, Buenos Aires (AR)

(73) Assignee: Allegro MicroSystems, LLC, Manchester, NH (US)

(21) Appl. No.: 17/331,981

(22) Filed: May 27, 2021

(51) Int. Cl. G01D 5/14; G01B 7/30

(52) U.S. Cl. CPC G01D 5/14; G01B 7/30

(57) ABSTRACT

A sensor, comprising: a processing circuitry configured to: receive a first signal that is generated by a first magnetic field sensing element, the first signal being generated in response to a magnetic field that is indicative of rotation of a target; identify N local maxima of the first signal, where N is a positive integer, and N>1; identify N local minima of the first signal; generate a first offset adjustment signal and a first gain adjustment signal based on: (i) a first sum of the local maxima of the first signal and (ii) a second sum of the local minima of the first signal; and adjust the first signal based on the first offset adjustment signal and the first gain adjustment signal.

### BACKGROUND

As is known, sensors are used to perform various functions in a variety of applications. Some sensors include one or magnetic field sensing elements, such as a Hall effect element or a magnetoresistive element, to sense a magnetic field associated with proximity or motion of a target object, such as a ferromagnetic object in the form of a gear or ring magnet, or to sense a current, as examples. Sensor integrated circuits are widely used in automobile control systems and other safety-critical applications. There are a variety of specifications that set forth requirements related to permissible sensor quality levels, failure rates, and overall functional safety.

### SUMMARY

According to aspects of the disclosure, a sensor is provided, comprising: a processing circuitry configured to: receive a first signal that is generated by a first magnetic field sensing element, the first signal being generated in response to a magnetic field that is indicative of rotation of a target; identify N local maxima of the first signal, each of the local maxima of the first signal including the largest value of the first signal during a different respective one of N electrical periods of the first signal, where N is a positive integer, and N>1; identify N local minima of the first signal, each of the local minima of the first signal including the smallest value of the first signal during a different respective one of the N electrical periods of the first signal; generate a first offset adjustment signal and a first gain adjustment signal based on: (i) a first sum of the local maxima of the first signal and (ii) a second sum of the local minima of the first signal; and adjust the first signal based on the first offset adjustment signal and the first gain adjustment signal.

According to aspects of the disclosure, a method is provided for use in a sensor, the method comprising: receiving a first signal that is generated by a first magnetic field sensing element, the first signal being generated in response to a magnetic field that is indicative of rotation of a target; identifying N local maxima of the first signal, each of the local maxima of the first signal including the largest value of the first signal during a different respective one of N electrical periods of the first signal, where N is a positive integer, and N>1; identifying N local minima of the first signal, each of the local minima of the first signal including the smallest value of the first signal during a different respective one of the N electrical periods of the first signal; generating a first offset adjustment signal and a first gain adjustment signal based on: (i) a first sum of the local maxima of the first signal and (ii) a second sum of the local minima of the first signal; and adjusting the first signal based on the first offset adjustment signal and the first gain adjustment signal.

According to aspects of the disclosure, a non-transitory computer-readable medium storing one or more processor-executable instructions, which, when executed by at least one processor, cause the at least one processor to perform the operations of: receiving a signal, the signal being generated by a sensing element in response to a magnetic field that is indicative of rotation of a target; identifying N local maxima of the signal, each of the local maxima of the signal including the largest value of the signal during a different respective one of N electrical periods of the signal, where N is a positive integer, and N>1; identifying N local minima of the signal, each of the local minima of the signal including the smallest value of the signal during a different respective one of the N electrical periods of the signal; generating an offset adjustment signal and a gain adjustment signal based on: (i) a first sum of the local maxima of the signal and (ii) a second sum of the local minima of the signal; and adjusting the signal based on the offset adjustment signal and the gain adjustment signal.

According to aspects of the disclosure, a sensor is provided, comprising; means for receiving a signal, the signal being generated by a sensing element in response to a magnetic field that is indicative of rotation of a target; means for identifying N local maxima of the signal, each of the local maxima of the signal including the largest value of the signal during a different respective one of N electrical periods of the signal, where N is a positive integer, and N>1; means for identifying N local minima of the signal, each of the local minima of the signal including the smallest value of the signal during a different respective one of the N electrical periods of the signal; means for generating an offset adjustment signal and a gain adjustment signal based on: (i) a first sum of the local maxima of the signal and (ii) a second sum of the local minima of the signal; and means for adjusting the signal based on the offset adjustment signal and the gain adjustment signal.

### BRIEF DESCRIPTION OF THE DRAWINGS

The foregoing features may be more fully understood from the following description of the drawings in which:

FIG. 1A is a diagram of an example of a sensor, according to aspects of the disclosure;

FIG. 1B is a plot of a graph, according to aspects of the disclosure;

FIG. 1C is a plot of a graph, according to aspects of the disclosure;

FIG. 1D is a plot of a graph, according to aspects of the disclosure;

FIG. 2 is a diagram of an example of a sensor, according to aspects of the disclosure;

FIG. 3 is a diagram of an example of an electronic circuit, according to aspects of the disclosure;

FIG. 4 is a flowchart of an example of a process, according to aspects of the disclosure; and

FIG. 5 is a flowchart of an example of a process, according to aspects of the disclosure.

### DETAILED DESCRIPTION

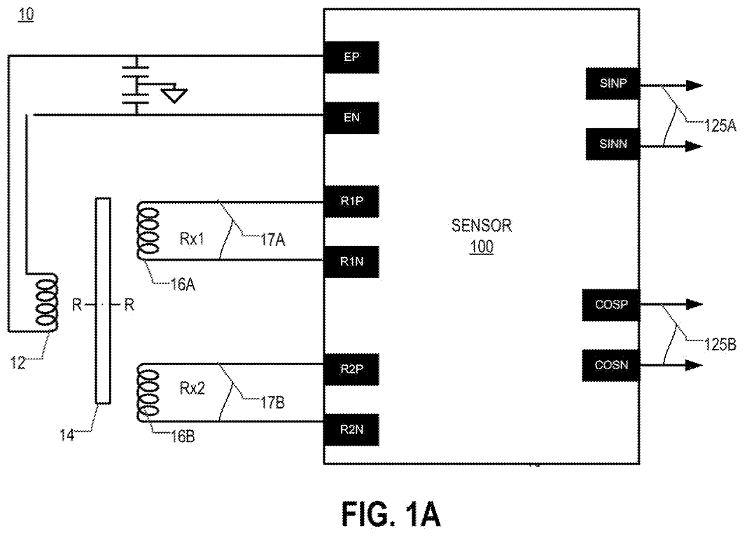

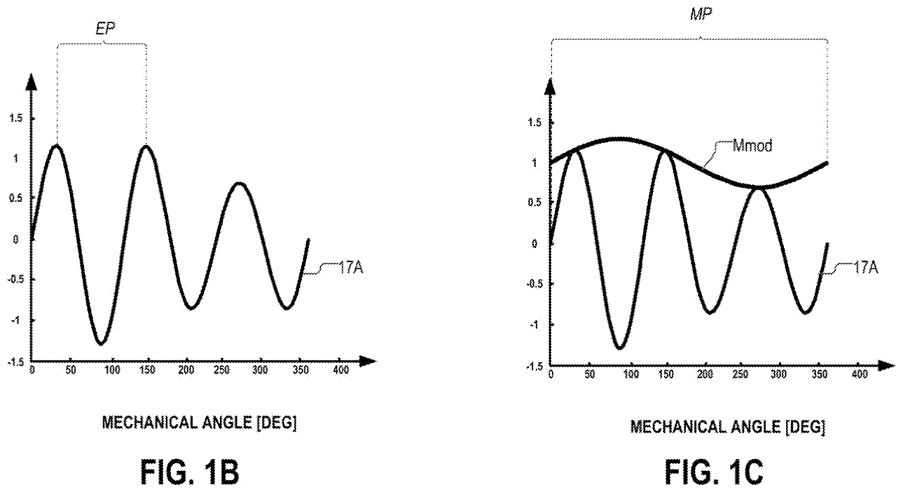

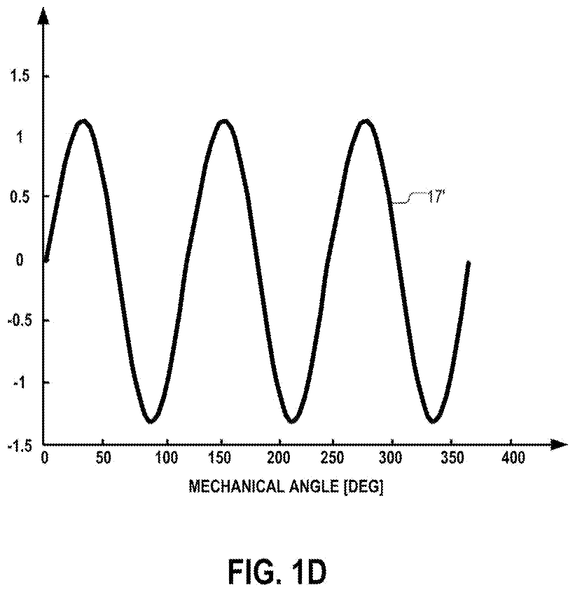

FIG. 1A is a diagram of an example of a system 10, according to aspects of the disclosure. As illustrated, the system 10 may include a sensor 100, a target 14, an excitation coil 12, and receiver coils 16A and 16B. The sensor 100, according to the example of FIG. 1A, includes an inductive position sensor. The target 14, according to the example of FIG. 1A, includes a metal object (e.g., a gear) that is arranged to rotate about an axis of rotation R-R. The excitation coil 12 may include any suitable type of coil that is arranged to generate a first magnetic field. The excitation coil 12 may be coupled to driver pins EP and EN of the sensor 100. The receiver coil 16A may include any suitable type of coil that is arranged to receive a magnetic field that is produced by the target 14. The receiver coil 16A may be coupled to receiver coil pins R1P and R1N of the sensor 100. The receiver coil 16B may include any suitable type of coil that is arranged to receive a magnetic field that is produced by the target 14. The receiver coil 16B may be coupled to receiver coil pins R2P and R2N of the sensor 100.

The sensor 100 may be configured to drive the excitation coil 12 in a well-known fashion. The excitation coil 12 may generate a first magnetic field, as noted above. The first magnetic field may induce eddy currents in the rotating target 14, which in turn may cause the rotating target 14 to produce a second magnetic field. The receiver coil 16A may generate a signal 17A in response to the second magnetic field and apply the signal 17A at pins R1P and R1N. The receiver coil 16B may generate a signal 17B in response to the second magnetic field and apply the signal 17B at pins R2P and R2N. The sensor 100 may generate signals 125A and 125B based on the signals 17A and 17B. The signal 125A may be output on pins SINP and SINN of the sensor 100. The signal 125A may a reconstructed sinusoid signal. The signal 125A may be indicative of at least one of angular position, speed, direction, and/or acceleration of the rotating target 14. The signal 125B may be output on pins COSP and COSN of the sensor 100. The signal 125B may a reconstructed co-sinusoid signal. The signal 125B may be indicative of at least one of angular position, speed, direction, and/or acceleration of the rotating target 14.

A misalignment between the target 14 and the sensor 100 may impart a mechanical modulation on the signal 17A (and the signal 17B). The effects of the mechanical modulation of the signal 17A are illustrated in FIGS. 1B-C. FIG. 1B shows a plot of the signal 17A. FIG. 1B illustrates that the mechanical modulation may cause the signal 17A to have uneven peaks. FIG. 1C shows a combined plot of the signal 17A and a curve Mmod. The curve Mmod, as illustrated, models the mechanical modulation that is imparted on the signal 17A as a result of the misalignment between the target 14 and the sensor 100, and it represents the upper envelope of the signal 17A.

FIGS. 1B-C further illustrate the distinction between an electrical period EP of the signal 17A and a mechanical period MP of the target 14. By way of example, the electrical period EP of the signal 17A may be the time (and/or angular displacement of the target 14) between two successive local maxima of the signal 17A. In some respects, the electrical period of the signal 17A may be the period of the waveform of the signal 17A. Furthermore, the electrical period of the signal 17A may also be defined as the time (and/or angular displacement of the target 14) between two successive local minima of the signal 17A, the time (and/or angular displacement of the target 14) it takes the signal to return to 0 after it has surpassed the same value, and/or in any other suitable manner. The mechanical period MP of the target 14 may be the time it takes the target 14 to complete one full rotation relative to the sensor 100. Notably, the mechanical period of the target 14 may be the same as the period of the curve Mmod. As noted above, the curve Mmod models the mechanical modulation that is imparted on the signal 17A by the target 14.

According to the example of FIGS. 1B-C, three electrical periods EP of the signal 17A occur in one mechanical period of the target. However, it will be understood that this number can vary. In general, the number of electrical periods of a signal that is generated in response to a magnetic field produced by a target may depend on the number of magnetic pole pairs in the target, the number of lobes in a receiver coil that is used to generate the signal, and/or on other design parameters. In this regard, it will be understood that the present disclosure is not limited to any specific number of electrical periods PE of the signal 17A occurring in one mechanical period of the target 14.

The phrase “mechanical misalignment between a target and a sensor” shall refer to at least one of (i) a misalignment between the target and the sensor, and/or or (ii) a misalignment between the target and a sensing element that is used by the sensor to sense a magnetic field that is produced by the target. The sensing element may be part of the sensor or it may be provided externally of the sensor (as in the example of FIG. 1A). In some instances, a sensor may be misaligned with the target as a result of manufacturing tolerances or tolerances in the installation of at least on the sensor, the target, and/or a sensing element that is used by the sensor to sense a magnetic field generated by the target.

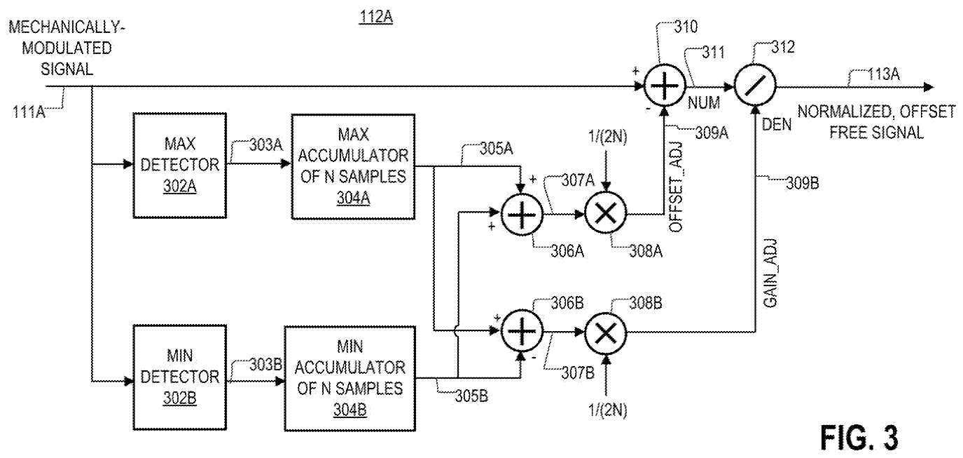

According to aspects of the disclosure, the sensor 100 employs a signal processing technique that corrects, at least in part, the effects of mechanical modulation that is imparted on the signal as a result of a misalignment between the target 14 and the sensor 100. FIG. 1D shows an example of a signal 17A′ that is generated as a result of applying the signal processing technique on the signal 17A to compensate for the mechanical modulation that is imparted on the signal 17A as a result of a misalignment between the sensor 100 and target 14. As illustrated in FIG. 1D, processing the signal 17A in accordance with the signal processing technique may ideally produce a signal 17A′, whose positive and negative peaks are substantially even (or at least less uneven). The signal processing technique is discussed in further detail with respect to FIGS. 3-5. Although the signal processing technique is discussed in the context of the sensor 100, it will be understood that the present disclosure is not limited to the technique being employed on any specific type of magnetic field sensor. Furthermore, it will be understood that the present disclosure is not limited to executing the signal processing technique with any specific type of processing circuitry.

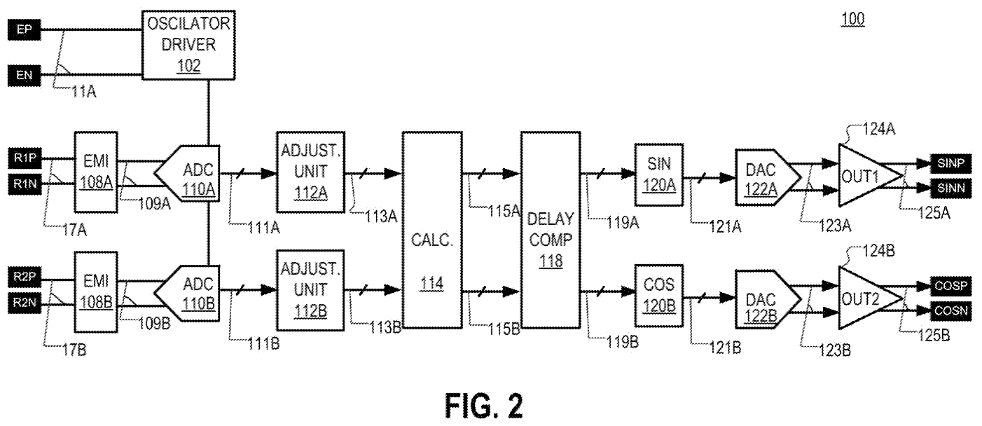

FIG. 2 is a diagram of the sensor 100, according to aspects of the disclosure. As illustrated, the sensor 100 may include an oscillator 102, EMI filters 108A and 108B, analog-to-digital converters (ADC) 110A and 110B, adjustment units 112A and 112B, a calculator 114, a delay and compensation unit 118, a sine element 120A, a cosine element 120B, digital-to-analog converters (DACs) 122A and 122B, and output drivers 124A and 124B.

The EMI filter 108A may receive the signal 17A over pins R1P and R1N. The EMI filter 108A may filter the signal 17A to produce a filtered signal 109A. The ADC 110A may digitize the signal 109A to produce a signal 111A. The adjustment unit 112A may adjust the gain and/or offset of the signal 111A to produce a signal 113A. The EMI filter 108B may receive the signal 17B over pins R2P and R2N. The EMI filter 108B may filter the signal 17B to produce a filtered signal 109B. The ADC 110B may digitize the signal 109B to produce a signal 111B. The adjustment unit 112B may adjust the gain and/or offset of the signal 111B to produce a signal 113B.

The calculator 114 may generate signals 115A and 115B based on signals 113A and 113B. In some implementations, each of signals 115A and 115B may include a stream of angle values, wherein each of the angle values corresponds to a current angular position of the target. The delay compensation unit 118 may perform delay compensation on the signal 115A to produce a signal 119A. In some implementations, the delay compensation unit 118 may adjust the signal 115A to compensate for the effective path latency of the sensor 100. The delay compensation unit 118 may also perform delay compensation on the signal 115B to produce a signal 119B. In some implementations, the delay compensation unit 118 may adjust the signal 115B to compensate for the effective path latency of the sensor 100.

The sine element 120A may transform the signal 119A into a differential sine signal 121A. The digital-to-analog converter (DAC) 122A may convert the signal 121A to analog signal 123A. The output driver 124A may generate a signal 125A based on the signal 123A. The output driver 124A may output the signal 125A on pins SINP and SINN, as shown. The cosine element 120B may transform the signal 119B into a differential cosine signal 121B. The digital-to-analog converter (DAC) 122B may convert the signal 121B to analog signal 123B. The output driver 124B may generate a signal 125B based on the signal 123B. The output driver 124B may output the signal 125B on pins COSP and COSN, as shown.

Although in the example of FIG. 2, signals 17A, 109A, 111A, and 113A are referred to as different signals, it will be understood that each of the signals 109A, 111A, and 113 may also be considered to be a respective instance of the signal 17A, at a different stage of the processing of the signal 17A. Although in the example of FIG. 2, signals 17B, 109B, 111B, and 113B are referred to as different signals, it will be understood that each of the signals 109B, 111B, and 113B may also be considered to be a respective instance of the signal 17B, at a different stage of the processing of the signal 17B.

FIG. 3 is a diagram of an example of the adjustment unit 112A, according to aspects of the disclosure. Although FIG. 3 provides an example of a circuit that may be part of the adjustment unit 112A, it will be understood that in some implementations, the adjustment unit 112B may also include the circuit that is shown in FIG. 3.

The adjustment unit 112A is configured to receive the signal 111A and output the signal 113A. As noted above, the signal 111A is generated by conditioning (or processing) the signal 17A. Accordingly, the signal 111A is subject to the same mechanical modulation as the signal 17A. The adjustment unit 112A may adjust the signal 111A to compensate for the effects of the mechanical modulation. Accordingly, the signal 113A may be the same or similar to the signal 17A′, which is discussed above with respect to FIG. 1D.

To correct (at least partially) for the effects of mechanical modulation, the adjustment unit 112A may: (i) adjust the offset of the signal 111A based on an offset adjustment signal 309A, and (ii) adjust the gain of the signal 111A based on a gain adjustment signal 309B. In some implementations, the offset adjustment signal 309A and the gain adjustment signal 309B may be calculated in accordance with Equations 1 and 2, below:

$$gain\_adjustment \_signal = \frac{{\sum }_{i = 1}^{N} {Max}_{i} - {\sum }_{i = 1}^{N} {Min}_{i}}{2 \cdot N} \qquad ( 1 )$$

$$offset\_adjustment \_signal = \frac{{\sum }_{i = 1}^{N} {Max}_{i} + {\sum }_{i = 1}^{N} {Min}_{i}}{2 \cdot N} \qquad ( 2 )$$

where N is a count of electrical periods in the signal 111A that occur during one full rotation of the target 14, Maxᵢ is the local maximum of the first signal for the i-th electrical period of the first signal, and Minᵢ is the local minimum of the first signal for the i-th electrical period of the first signal.

The terms “gain adjustment coefficient” and “gain adjustment signal” may be used interchangeably, when the context permits. The gain adjustment signal 309B may be a stream of values of a gain adjustment coefficient. In this regard, at any given time, adjusting the gain of the signal 111A based on the gain adjustment signal 309B may include multiplying the instant value of the signal 111A by the (inverse of the) instant value of the gain adjustment coefficient (i.e., the instant value of the gain adjustment signal 309B). The terms “offset adjustment coefficient” and “offset adjustment signal” may be used interchangeably, when the context permits. The offset adjustment signal 309A may be a stream of values of an offset adjustment coefficient. In this regard, at any given time, adjusting the offset of the signal 111A based on the offset adjustment signal 309A may include subtracting the instant value of the offset adjustment coefficient (i.e., the instant value of the offset adjustment signal 309A) from the instant value of the signal 111B.

As illustrated in FIG. 3, the adjustment unit 112A may include a max detector 302A, an accumulator register 304A, a min detector 302B, an accumulator register 304B, a summation unit 306A, a summation unit 306B, a multiplication unit 308A, a multiplication unit 308B, a summation unit 310, and a division element 312.

The max detector 302A may include any suitable type of processing circuitry that is configured to identify local maxima in the signal 111A. The accumulator register 304A may include any suitable type of accumulator register that is configured to calculate the sum of N most recent local maxima of the signal 111A. According to the present example, the value of N is equal to the number of electrical periods in the signal 111A that correspond to one mechanical period of a target. The min detector 302B may include any suitable type of processing circuitry that is configured to identify local minima in the signal 111A. The accumulator register 304B may include any suitable type of accumulator register that is configured to calculate the sum of N most recent local minima of the signal 111A.

The max detector 302A may generate a signal 303A, and provide the signal 303A to the accumulator register 304A. The signal 303A may include a stream of values, wherein each value corresponds to a different local maximum of the signal 111A. The accumulator register 304A may generate a signal 305A, and provide the signal 305A to summation units 306A and 306B. The signal 305A may include a stream of values, wherein each value is equal to the sum of the N most recent values of the signal 303A.

The min detector 302B may generate a signal 303B, and provide the signal 303B to the accumulator register 304B. The signal 303B may include a stream of values, wherein each value corresponds to a different local minimum of the signal 111A. The accumulator register 304B may generate a signal 305B, and provide the signal 305B to summation units 306A and 306B. The signal 305B may include a stream of values, wherein each value is equal to the sum of the N most recent values of the signal 303B.

The summation unit 306A may add signals 305A and 305B to produce a signal 307A. The signal 307A may include a stream of values, wherein each value corresponds to the sum of a value of the signal 305A and a value of the signal 305B. The summation unit 306B may subtract the signal 305B from the signal 305A to produce a signal 307B. The signal 307B may include a stream of values, wherein each value corresponds to the difference between a value of the signal 305A and a value of the signal 305B.

The multiplication unit 308A may multiply the signal 307A by ‘1/2N’ to produce a signal 309A. The offset adjustment signal 309A may include a stream of values, wherein each value is equal to the quotient of a value of the signal 307A and ‘2N’. The summation unit 310 may subtract the signal 309A from the signal 111A to produce a signal 311. The signal 311 may include a stream of values, wherein each value is equal to the difference of a value of the signal 111A and a value of the offset adjustment signal 309A. The division unit may divide the signal 311 by the gain adjustment signal 309B to produce the signal 113A.

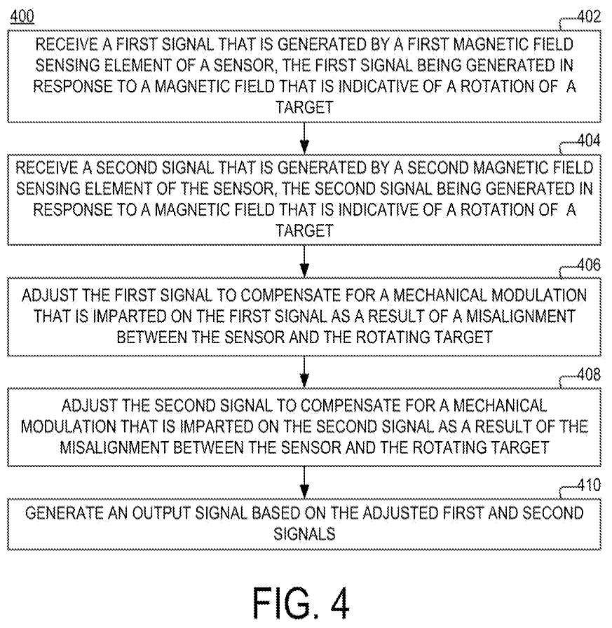

FIG. 4 is a flowchart of an example of a process 400, according to aspects of the disclosure. According to the example of FIG. 4, the process 400 is performed by a sensor, and more particularly by processing circuitry that is integrated into the sensor. The sensor may be configured to detect a magnetic field that is indicative of the rotation of a target. According to the example of FIG. 4, the purpose of the process 400 may be to correct errors that result from a misalignment between the sensor and the target.

At step 402, a first signal is received that is generated by a first magnetic field sensing element. The first magnetic field sensing element may be the same or similar to the receiver coil 16A (shown in FIG. 1A), and it may be coupled to (and/or integrated in) a sensor, such as the sensor 100 (shown in FIG. 1A). The first signal is generated in response to a magnetic field that is indicative of the rotation of a target. The target may be the same or similar to the target 14, which is discussed above with respect to FIG. 1A. The first signal may be the same or similar to the signal 17A, which is discussed above with respect to FIG. 1A.

At step 404, a second signal is received that is generated by a second magnetic field sensing element. The second magnetic field sensing element may be the same or similar to the receiver coil 16B (shown in FIG. 1A), and it may be coupled to (and/or integrated in) a sensor, such as the sensor 100 (shown in FIG. 1A). The second signal is generated in response to a magnetic field that is indicative of the rotation of the target. The second signal may be the same or similar to the signal 17B, which is discussed above with respect to FIG. 1A.

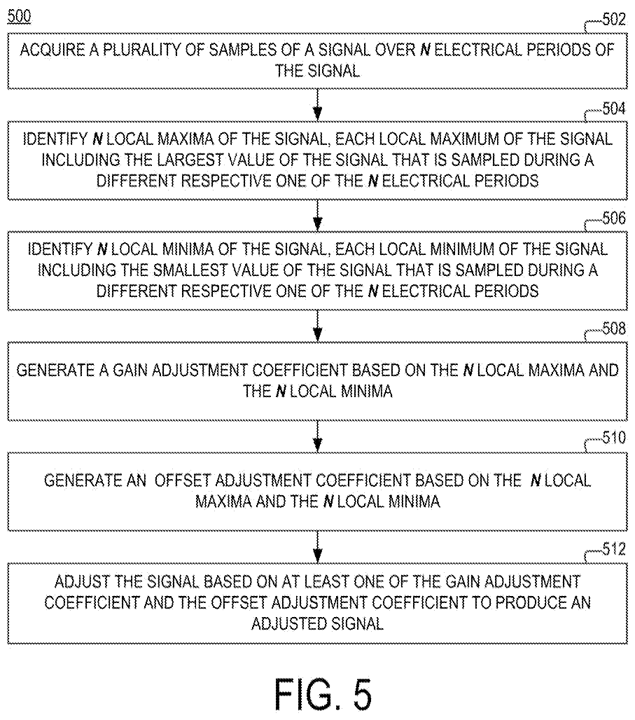

At step 406, the first signal is adjusted to compensate for a misalignment of the sensor and the target. In some implementations, the first signal may be adjusted in accordance with a process 500, which is discussed further below with respect to FIG. 5.

At step 408, the second signal is adjusted to compensate for a misalignment of the sensor and the target. In some implementations, the second signal may be adjusted in accordance with a process 500, which is discussed further below with respect to FIG. 5.

At step 410, an output signal is generated based on at least one of the first signal and the second signal. The output signal may be generated after the first and/or second signals are adjusted at steps 406 and 408, respectively. The output signal may be indicative of at least one of angular position, speed, direction, and/or acceleration of the target. The output signal may be generated in a well-known fashion. In some implementations, the output signal may be generated after additional compensations are performed on the first and/or second signals, such as temperature compensation, humidity compensation, pressure compensation, etc.

According to the example of FIG. 4, the first magnetic field sensing element is the same or similar to the receiver coil 16A. However, alternative implementations are possible in which another type of magnetic field sensing element is used, such as a Hall element, a giant magnetoresistive (GMR) element, a tunnel magnetoresistive (TMR) element. Stated succinctly, the present disclosure is not limited to any specific implementation of the first magnetic field sensing element.

According to the example of FIG. 4, the second magnetic field sensing element is the same or similar to the receiver coil 16B. However, alternative implementations are possible in which another type of magnetic field sensing element is used, such as a Hall element, a giant magnetoresistive (GMR) element, a tunnel magnetoresistive (TMR) element. Stated succinctly, the present disclosure is not limited to any specific implementation of second magnetic field sensing element.

According to the example of FIG. 4, the first magnetic field sensing element is provided separately from the sensor (that performs the process 400). However, alternative implementations are possible in which the first sensing element is integrated into the sensor. According to the example of FIG. 4, the second magnetic field sensing element is provided separately from the sensor (that performs the process 400). However, alternative implementations are possible in which the second sensing element is integrated into the sensor. Stated succinctly, the present disclosure is not limited to any specific implementation of the sensor.

According to the example of FIG. 4, the target is similar to the target 14. However, it will be understood that the present disclosure is not limited to any specific implementation of the target. For example, in some implementations, the target may include one or more of a permanent magnet, an electromagnet, a gear, a ferromagnetic object which is used with a back biased magnet, a shaft, a wheel, and/or any other suitable type of element.

According to the example of FIG. 4, the sensor (performing the process 400) is an angle sensor. However, alternative implementations are possible in which the sensor is a position sensor, and/or any other suitable type of magnetic field sensor. Although in the example of FIG. 4, the process 400 is performed by processing circuitry that is integrated into a sensor, it will be understood that the present disclosure is not limited to any specific implementation of the processing circuitry executing the process 400.

As used throughout the disclosure, the term “processing circuitry” may refer to one or more of analog circuitry, digital circuitry, digital logic, a general-purpose processor, a special-purpose processor, an application-specific processor, a digital circuit processor, a field-programmable gate array (FPGA), and/or any other suitable type of electronic circuit. A non-limiting example of processing circuitry includes at least one of the adjustment units 112A-B and/or the calculator 114, which are shown in FIG. 2. Another non-limiting example of processing circuitry includes the adjustment unit 112A, which is discussed above with respect to FIG. 3.

FIG. 5 is a flowchart of an example of a process 500 for performing steps 406 and 408, which are discussed above with respect to FIG. 4. Although in the example of FIG. 5, the process 500 is presented in the context of the first signal (received at step 402), it will be understood that the process 500 may be used to process the second signal (received at step 404) in the same manner.

At step 502, a plurality of samples of the first signal is acquired over at least N electrical periods of the first signal. According to the present example, N is a positive integer, and N>1.

At step 504, N local maxima of the first signal are identified. According to the present example, each of the local maxima includes a local maximum of the first signal that occurs during a different one of the N electrical periods. In some implementations, the local maximum of the first signal for a particular electrical period of the first signal may include the value of the positive peak of the first signal in that electrical period. Additionally or alternatively, in some implementations, the local maximum of the first signal for a particular electrical period of the first signal may include the smallest sample of the first signal that is obtained during that electrical period. In some implementations, identifying the largest sample for a given electrical period and using it as a local maximum is advantageous because the largest sample can be obtained more easily than the exact value of the local maximum, while the error resulting from using the largest sample instead of a local maximum is low (provided that the signal is sampled at a sufficient rate).

At step 506, N local minima of the first signal are identified. According to the present example, each of the local minima includes a local minimum of the first signal that occurs during a different one of the N-sampling periods. In some implementations, the local minimum of the first signal for a particular electrical period of the first signal may include the value of the negative peak of the first signal in that electrical period. Additionally or alternatively, in some implementations, the local minimum of the first signal for a particular electrical period of the first signal may include the smallest sample of the first signal that is obtained during that electrical period. In some implementations, identifying the smallest sample for a given electrical period and using it as a local minimum is advantageous because the smallest sample can be obtained more easily than the exact value of the local minimum, while the error resulting from using the smallest sample instead of the exact value of the local minimum is low (provided that the signal is sampled at a sufficient rate).

At step 508, a gain adjustment coefficient is generated based on the N local maxima (identified at step 504) and the N local minima (identified at step 506). The gain adjustment coefficient may be generated in accordance with Equation 1, above. More particularly, the gain adjustment coefficient may be calculated by: (i) calculating a first sum of the N local maxima, (ii) calculating a second sum of the N local minima, (iii) calculating a difference of the first sum and the second sum, and (iv) dividing the difference by 2N.

At step 510, an offset adjustment coefficient is generated based on the N local maxima (identified at step 504) and the N local minima (identified at step 506). The offset adjustment coefficient may be generated in accordance with Equation 2, above. More particularly, the gain adjustment coefficient may be calculated by: (i) calculating a first sum of the N local maxima, (ii) calculating a second sum of the N local minima, (iii) calculating a third sum of the first sum and the second sum, and (iv) dividing the third sum by 2N.

At step 512, the first signal is adjusted based on at least one of the gain adjustment coefficient and the offset adjustment coefficient. Specifically, the first signal may be adjusted by subtracting the offset adjustment coefficient (calculated at step 510) from the first signal to produce an offset-adjusted signal, and then dividing the offset-adjusted signal by the gain adjustment coefficient (calculated at step 508).

An approach is now described for deriving the model that is represented by the equations for calculating the gain and offset adjustment coefficients (i.e., Equations 1 and 2). The approach is presented in the context of processing the signal 17A (shown in FIGS. 1A-2). However, it will be understood that the approach can be applied to processing any similar signal.

Signal 17A may be represented by Equation 3 below:

S_{17A}=M_{mod}·S_{125A}=M_{mod}·sin(θₑ+ϕ_{S}) (3)

where S17A is signal 17A, S_{125A} is signal 125A, and Mmod is the model for the mechanical modulation that is imparted on the output of the receiver coil 16A as a result of a misalignment between the target 14 and the sensor 100, θₑ is the electrical angle of the signal 17A, and ϕ_{S} is the phase of signal 125A. Signal S_{125A}, according to the example of Equation 3, is what would ideally be output by the receiver coil 16A if no mechanical modulation were imparted on the output of the receiver coil 16A.

The mechanical modulation Mmod may be modeled in accordance with Equations 4-7 below:

$${M}_{m o d} = {\sum }_{h = 0}^{∞} {a}_{{m}_{h}} \cdot sin ( h \cdot {θ}_{m} + {φ}_{{m}_{h}} ) = {A}_{{m}_{0}} + {\sum }_{h = 1}^{∞} {a}_{{m}_{h}} \cdot sin ( h \cdot {θ}_{m} + {φ}_{{m}_{h}} ) \qquad ( 4 )$$

$$M \_mod = {A}_{{m}_{0}} + {\sum }_{h = 1}^{H} {a}_{{m}_{h}} \cdot sin ( h \cdot {θ}_{m} + {φ}_{{m}_{h}} ) \qquad ( 5 )$$

$${\sum }_{h = H + 1}^{∞} {a}_{{m}_{h}} \cdot sin ( h \cdot {θ}_{m} + {φ}_{{m}_{h}} ) \approx 0 \qquad ( 6 )$$

$${A}_{{m}_{0}} = {a}_{{m}_{0}} \cdot sin ( {φ}_{{m}_{0}} ) \qquad ( 7 )$$

where θₘ is the mechanical angle of the target 14, H is the number of relevant harmonic terms, aₘ_{ₕ} is the amplitude of sinusoidal wave h in M_{mod}, φₘ_{ₕ} is the phase of sinusoidal wave h in M_{mod}, and Aₘ_{₀} is the mean value of M_{mod}.

Based on equations, 3-7, the signal 17A may be also expressed by equation 8 below:

S_{17A}=Sens_{c}·M_{mod}·sin(θₑ+ϕ_{C})+Offset_{C} (8)

where Sens_{C} is the amplitude of the mechanical modulation that is imparted on the output of the receiver coil 16A, and Offset_{C} is the offset of the mechanical modulation that is imparted on the output of the receiver coil 16A.

Applying Fourier's transform, Equation 8 can be re-written as Equations 9 and 11, below:

$${S}_{17 A} = S e n {s}_{C} \cdot {A}_{{m}_{0}} \cdot sin ( {θ}_{e} + {ϕ}_{C} ) + {Offset}_{C} + sin ( {θ}_{e} + {ϕ}_{C} ) \cdot {\sum }_{h = 1}^{H} {a}_{{m}_{h}} \cdot sin ( h \cdot {θ}_{m} + {φ}_{{m}_{i}} ) \qquad ( 9 )$$

$${A}_{C} = S e n {s}_{C} \cdot {A}_{{m}_{0}} \qquad ( 10 )$$

$${S}_{17 A} = {A}_{C} \cdot sin ( {θ}_{e} + {ϕ}_{C} ) + {Offset}_{C} + S e n {s}_{C} \cdot sin ( {θ}_{e} + {ϕ}_{C} ) \cdot {\sum }_{h = 1}^{H} {a}_{{m}_{h}} \cdot sin ( h \cdot {θ}_{m} + {φ}_{{m}_{i}} ) \qquad ( 11 )$$

where Ac is the mean amplitude of the signal 17A.

If signal 17A is sampled at sin(θₑ+ϕ_{C})=±1, Min samples for the signal 17A will be obtained at θₑ=2·π·

$${θ}_{e} = 2 \cdot π \cdot i - \frac{π}{2} - {ϕ}_{C}$$

and Max samples for the signal 17A will be obtained at θₑ=2·π·

$${θ}_{e} = 2 \cdot π \cdot i + \frac{π}{2} - {ϕ}_{C}$$

(i∈Z indicating the index of the electrical period). The minimum and maximum samples may or may not be the actual positive and negative peaks of the signal 17A as they are affected by the modulation term.

The minimum and maximum samples of the signal 17A may be expressed by equations 12 and 13 below:

$${Max}_{{C}_{i}} = {A}_{C} + {Offset}_{C} + {Sens}_{C} \cdot {\sum }_{h = 1}^{H} {a}_{{m}_{h}} \cdot sin ( h \cdot \frac{2 \cdot π \cdot i + \frac{π}{2} - {ϕ}_{C}}{N} + {φ}_{m} ) \qquad ( 12 )$$

$${Min}_{{C}_{i}} = - {A}_{C} + {Offset}_{C} - {Sens}_{C} \cdot {\sum }_{h = 1}^{H} {a}_{{m}_{h}} \cdot sin ( h \cdot \frac{2 \cdot π \cdot i - \frac{π}{2} - {ϕ}_{C}}{N} + {φ}_{m} ) \qquad ( 13 )$$

where Max_{C} is a maximum sample and Min_{C} is a minimum sample.

To obtain the mean values and cancel the mechanical modulation, the following sums of N samples must be defined for one period of M_{mod} (or N electrical periods).

$${\sum }_{i = 1}^{N} {Max}_{{C}_{i}} = N \cdot {A}_{C} + N \cdot {Offset}_{C} + S e n {s}_{C} \cdot {\sum }_{h = 1}^{H} {a}_{{m}_{h}} \cdot {\sum }_{i = 1}^{N} sin ( \frac{h}{N} \cdot ( 2 \cdot π \cdot i + \frac{π}{2} - {ϕ}_{C} ) + {φ}_{m} ) \qquad ( 14 )$$

$${\sum }_{i = 1}^{N} {Min}_{{C}_{i}} = - N \cdot {A}_{C} + N \cdot {Offset}_{C} - S e n {s}_{C} \cdot {\sum }_{h = 1}^{H} {a}_{{m}_{h}} \cdot {\sum }_{i = 1}^{N} sin ( \frac{h}{N} \cdot ( 2 \cdot π \cdot i - \frac{π}{2} - {ϕ}_{C} ) + {φ}_{m} ) \qquad ( 15 )$$

In the present example,

$${\sum }_{h = 1}^{H} {\sum }_{i = 1}^{N} sin ( \frac{h}{N} \cdot 2 \cdot π \cdot i + ψ ) = 0 ,$$

for ∀ψ and for N≥2·H, because: (A) equations 14 and 15 are defined for one period of M_{mod} and

$${\sum }_{i = 1}^{N} sin ( \frac{2 \cdot π \cdot i}{N} + ψ ) = 0. \qquad ( B )$$

Accordingly, Equations 14 and 15 can be rewritten as equations 16 and 17, respectively.

$${\sum }_{i = 1}^{N} {Max}_{{C}_{i}} = N \cdot {A}_{C} + N \cdot {Offset}_{C} \qquad ( 16 )$$

$${\sum }_{i = 1}^{N} {Min}_{{C}_{i}} = - N \cdot {A}_{C} + N \cdot {Offset}_{C} \qquad ( 17 )$$

Equations 16 and 17 can be re-written as equations 1 and 2, respectively.

In some respects, Equations 1 and 2 are based on the fact that the mechanical modulation that is imparted on signals 17A and 17B (shown in FIGS. 1A and 2) is periodic and that any periodic signal can be represented as a sum of sinusoidal functions. Hence, the mechanical modulation can be seen as a sum of this kind. Then, given a constant relationship between the electrical and mechanical periods of

$$Q = \frac{{θ}_{m}}{{θ}_{e}} ,$$

the samples taken from the signals 17A and 17B can be used to sample the signal M_{mod} at a constant angle step (which is an integer divisor of the mechanical period), thus reducing (or ideally removing) mechanical modulation effect from channel Max/Min samples. This requires each of the signals 17A and 17B to satisfy a kind of spatial Nyquist theorem, in which

$${\sum }_{i = 1}^{N} sin ( \frac{2 \cdot π \cdot i}{Q} + ψ ) = 0 ,$$

### and for ∀ψ and for Q≥2. Therefore,

$$N = \frac{{θ}_{m}}{{θ}_{e}} \geq 2 \cdot H ,$$

where H is the number of relevant harmonic terms of M_{mod} (as determined by the particular application in which Equations 1 and 2 are used).

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., a addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software.

According to the present disclosure, a magnetic field sensing element can include one or more magnetic field sensing elements, such as Hall effect elements, magnetoresistance elements, or magnetoresistors, and can include one or more such elements of the same or different types. As is known, there are different types of Hall effect elements, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A sensor, comprising:
a processing circuitry configured to:
receive a first signal that is generated by a first magnetic field sensing element, the first signal being generated in response to a magnetic field that is indicative of rotation of a target;
identify N local maxima of the first signal, each of the local maxima of the first signal including the largest value of the first signal during a different respective one of N electrical periods of the first signal, where N is a positive integer, and N>1;
identify N local minima of the first signal, each of the local minima of the first signal including the smallest value of the first signal during a different respective one of the N electrical periods of the first signal;
generate a first offset adjustment signal and a first gain adjustment signal based on: (i) a first sum of the local maxima of the first signal and (ii) a second sum of the local minima of the first signal; and
adjust the first signal based on the first offset adjustment signal and the first gain adjustment signal.

2. The sensor of claim 1, wherein adjusting the first signal compensates an offset and gain of the first signal for a mechanical modulation that is imparted on the first signal as a result of a mechanical misalignment between the sensor and the target.

3. The sensor of claim 1, wherein N is based on a count of electrical periods of the first signal that occur during one full rotation of the target.

4. The sensor of claim 1, wherein adjusting the first signal includes subtracting the first offset adjustment signal to the first signal to produce an offset-adjusted signal, and dividing the offset-adjusted signal by the first gain adjustment signal to produce an adjusted first signal.

5. The sensor of claim 1, wherein the first gain adjustment signal is generated in accordance with the following expression:
$$gain\_adjustment \_signal = \frac{{\sum }_{i = 1}^{N} {Max}_{i} - {\sum }_{i = 1}^{N} {Min}_{i}}{2 \cdot N}$$
where Maxᵢ is the local maximum of the first signal for the i-th electrical period of the first signal, and Minᵢ is the local minimum of the first signal for the i-th electrical period of the first signal.

6. The sensor of claim 1, wherein the first offset adjustment signal is generated in accordance with the following expression:
$$offset\_adjustment \_signal = \frac{{\sum }_{i = 1}^{N} {Max}_{i} + {\sum }_{i = 1}^{N} {Min}_{i}}{2 \cdot N}$$
where Maxᵢ is the local maximum of the first signal for the i-th electrical period of the first signal, and Minᵢ is the local minimum of the first signal for the i-th electrical period of the first signal.

7. The sensor of claim 1, wherein:
the processing circuitry is further configured to sample the first signal over the N electrical periods of the first signal,
each of the local maxima of the first signal includes the largest value of the first signal that is sampled during a different respective one of the N electrical periods, and
each of the local minima of the first signal includes the smallest value of the first signal that is sampled during a different respective one of the N electrical periods.

8. The sensor of claim 1, wherein:
the gain adjustment signal is generated based, at least in part, on a difference between the first sum and the second sum, and
the offset adjustment signal is generated, at least in part, by adding the first sum to the second sum.

9. The sensor of claim 1, wherein:
the first magnetic field sensing element includes at least one of a receiver coil, a Hall element, a giant magnetoresistive (GMR) element, or a tunnel magnetoresistive (TMR) element, and
the processing circuitry is further configured to generate an output signal based, at least in part, on the first signal, the output signal being generated after the first signal is adjusted, the output signal being indicative of at least one of angular position, speed, or acceleration of the target.

10. The sensor of claim 1, wherein the processing circuitry is further configured to:
receive a second signal that is generated by a second magnetic field sensing element, the second signal being generated in response to the magnetic field that is indicative of rotation of the target;
identify M local maxima of the second signal, each of the local maxima of the second signal including the largest value of the second signal during a different respective one of M electrical periods of the second signal, where M is a positive integer, and M>1;
identify M local minima of the second signal, each of the local minima of the second signal including the smallest value of the second signal during a different respective one of the M electrical periods of the second signal;
generate a second offset adjustment signal and a second gain adjustment signal based on: (i) a third sum of the local maxima of the second signal and (ii) a fourth sum of the local minima of the second signal; and
adjust the second signal based on the second offset adjustment signal and the second gain adjustment signal.

11. A method for use in a sensor, the method comprising:
receiving a first signal that is generated by a first magnetic field sensing element, the first signal being generated in response to a magnetic field that is indicative of rotation of a target;
identifying N local maxima of the first signal, each of the local maxima of the first signal including the largest value of the first signal during a different respective one of N electrical periods of the first signal, where N is a positive integer, and N>1;
identifying N local minima of the first signal, each of the local minima of the first signal including the smallest value of the first signal during a different respective one of the N electrical periods of the first signal;
generating a first offset adjustment signal and a first gain adjustment signal based on: (i) a first sum of the local maxima of the first signal and (ii) a second sum of the local minima of the first signal; and
adjusting the first signal based on the first offset adjustment signal and the first gain adjustment signal.

12. The method of claim 11, wherein adjusting the first signal compensates for a mechanical modulation that is imparted on the first signal as a result of a mechanical misalignment between the sensor and the target.

13. The method of claim 11, wherein N is based on a count of electrical periods of the first signal that occur during one full rotation of the target.

14. The method of claim 11, wherein adjusting the first signal includes subtracting the first offset adjustment signal to the first signal to produce an offset-adjusted signal, and dividing the offset-adjusted signal by the first gain adjustment signal to produce an adjusted first signal.

15. The method of claim 11, wherein the first gain adjustment signal is generated in accordance with the following expression:
$$gain\_adjustment \_signal = \frac{{\sum }_{i = 1}^{N} {Max}_{i} - {\sum }_{i = 1}^{N} {Min}_{i}}{2 \cdot N}$$
where Maxᵢ is the local maximum of the first signal for the i-th electrical period of the first signal, and Minᵢ is the local minimum of the first signal for the i-th electrical period of the first signal.

16. The method of claim 11, wherein the first offset adjustment signal is generated in accordance with the following expression:
$$offset\_adjustment \_signal = \frac{{\sum }_{i = 1}^{N} {Max}_{i} + {\sum }_{i = 1}^{N} {Min}_{i}}{2 \cdot N}$$
where Maxᵢ is the local maximum of the first signal for the i-th electrical period of the first signal, and Minᵢ is the local minimum of the first signal for the i-th electrical period of the first signal.

17. The method of claim 11, further comprising sampling the first signal over the N electrical periods of the first signal, wherein:
each of the local maxima of the first signal includes the largest value of the first signal that is sampled during a different respective one of the N electrical periods, and
each of the local minima of the first signal includes the smallest value of the first signal that is sampled during a different respective one of the N electrical periods.

18. The method of claim 11, wherein:
the gain adjustment signal is generated based, at least in part, on a difference between the first sum and the second sum, and
the offset adjustment signal is generated, at least in part, by adding the first sum to the second sum.

19. The method of claim 11, wherein the first magnetic field sensing element includes at least one of a receiver coil, a Hall element, a giant magnetoresistive (GMR) element, or a tunnel magnetoresistive (TMR) element, the method further comprising generating an output signal based, at least in part, on the first signal, the output signal being generated after the first signal is adjusted, the output signal being indicative of at least one of angular position, speed, or acceleration of the target.

20. The method of claim 11, further comprising:
receiving a second signal that is generated by a second magnetic field sensing element, the second signal being generated in response to the magnetic field that is indicative of rotation of the target;
identifying M local maxima of the second signal, each of the local maxima of the second signal including the largest value of the second signal during a different respective one of M electrical periods of the second signal, where M is a positive integer, and M>1;
identifying M local minima of the second signal, each of the local minima of the second signal including the smallest value of the second signal during a different respective one of the M electrical periods of the second signal;
generating a second offset adjustment signal and a second gain adjustment signal based on: (i) a third sum of the local maxima of the second signal and (ii) a fourth sum of the local minima of the second signal; and
adjusting the second signal based on the second offset adjustment signal and the second gain adjustment signal.

21. A non-transitory computer-readable medium storing one or more processor-executable instructions, which, when executed by at least one processor, cause the at least one processor to perform the operations of:
receiving a signal, the signal being generated by a sensing element in response to a magnetic field that is indicative of rotation of a target;
identifying N local maxima of the signal, each of the local maxima of the signal including the largest value of the signal during a different respective one of N electrical periods of the signal, where N is a positive integer, and N>1;
identifying N local minima of the signal, each of the local minima of the signal including the smallest value of the signal during a different respective one of the N electrical periods of the signal;
generating an offset adjustment signal and a gain adjustment signal based on: (i) a first sum of the local maxima of the signal and (ii) a second sum of the local minima of the signal; and
adjusting the signal based on the offset adjustment signal and the gain adjustment signal.

22. The non-transitory computer-readable medium of claim 21, wherein adjusting the signal compensates for a mechanical modulation that is imparted on the signal as a result of a mechanical misalignment between the target and the sensing element.

23. The non-transitory computer-readable medium of claim 21, wherein:
the one or more processor-executable instructions, when executed by the at least one processor, further cause the at least one processor to perform the operation of sampling the signal over the N electrical periods of the signal,
each of the local maxima of the signal includes the largest value of the signal that is sampled during a different respective one of the N electrical periods, and
each of the local minima of the signal includes the smallest value of the signal that is sampled during a different respective one of the N electrical periods of the signal.

24. A sensor, comprising;
means for receiving a signal, the signal being generated by a sensing element in response to a magnetic field that is indicative of rotation of a target;
means for identifying N local maxima of the signal, each of the local maxima of the signal including the largest value of the signal during a different respective one of N electrical periods of the signal, where N is a positive integer, and N>1;
means for identifying N local minima of the signal, each of the local minima of the signal including the smallest value of the signal during a different respective one of the N electrical periods of the signal;
means for generating an offset adjustment signal and a gain adjustment signal based on: (i) a first sum of the local maxima of the signal and (ii) a second sum of the local minima of the signal; and
means for adjusting the signal based on the offset adjustment signal and the gain adjustment signal.

25. The sensor of claim 24, wherein adjusting the signal compensates for a mechanical modulation that is imparted on the signal as a result of a mechanical misalignment between the sensor and the target.

26. The sensor of claim 24, further comprising means for sampling the signal over the N electrical periods of the signal, wherein:
each of the local maxima of the signal includes the largest value of the signal that is sampled during a different respective one of the N electrical periods, and
each of the local minima of the signal includes the smallest value of the signal that is sampled during a different respective one of the N electrical periods.
